(19) United States
(12) Patent Application Publication
(10) Pub. No.: US 2026/0106360 A1
(43) Pub. Date: Apr. 16, 2026

(54) Charging Fixture and Method for a Rechargable Battery

(71) Applicant: Ecells, Inc, Pahrump, NV (US)

(72) Inventor: David Cleveland, Pahrump, NV (US)

(21) Appl. No.: 18/913,690

(22) Filed: Oct. 11, 2024

(51) Int. Cl. H01M 50/673; A62C 3/16; H01M 10/44; H01M 10/46; H01M 10/48; H01M 50/581; H02J 7/00

(52) U.S. Cl. CPC H01M 50/673; A62C 3/16; H01M 10/44; H01M 10/46; H01M 10/488; H01M 50/581; H02J 7/663; H02J 7/70; H01M 2200/10

(57) ABSTRACT

A charging system and associated methods for charging rechargeable batteries are shown. Examples include a fire suppressant, and a surface suspended over the fire suppressant. One example includes a thermally activated actuator coupled to the surface allowing a charging battery to drop into the fire suppressant. Another example includes a thermally destructible surface suspended over the fire suppressant.

### TECHNICAL FIELD

This invention relates to rechargeable batteries and battery packs for electrical devices.

### BACKGROUND

Any number of electrical devices utilize rechargeable batteries. In many examples the batteries are included in a battery pack that is separable from the device for convenience in charging. Larger devices can be unwieldly to move near an outlet for charging. One example of an electrical device includes E-bikes. Battery packs for E-bikes require larger amounts of energy storage, and the battery packs are often separable from the E-bike for convenience in the charging operation.

Lithium-ion batteries are often used in battery packs for E-bikes. If damaged, battery packs such as lithium-ion battery packs can go into thermal runaway during charging. Thermal runaway in lithium-ion battery packs is dangerous, and secondary fires can result if the thermal runaway is not properly contained.

What is needed is a system and method to address these concerns and other technical challenges related to rechargeable batteries.

### BRIEF DESCRIPTION OF THE DRAWINGS

FIG. 1 shows a charging system according to an embodiment of the invention.

FIG. 2 shows another charging system according to an embodiment of the invention.

FIG. 3 shows another charging system during thermal runaway according to an embodiment of the invention.

FIG. 4 shows the charging system of FIG. 3 suppressing a fire according to an embodiment of the invention.

FIG. 5 shows another charging system during thermal runaway according to an embodiment of the invention.

FIG. 6 shows the charging system of FIG. 5 suppressing a fire according to an embodiment of the invention.

FIG. 7A shows another charging system during thermal runaway according to an embodiment of the invention.

FIG. 7B shows the charging system of FIG. 7A suppressing a fire according to an embodiment of the invention.

FIG. 8 shows an example method of charging a rechargeable battery according to an embodiment of the invention.

### DETAILED DESCRIPTION

1 In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

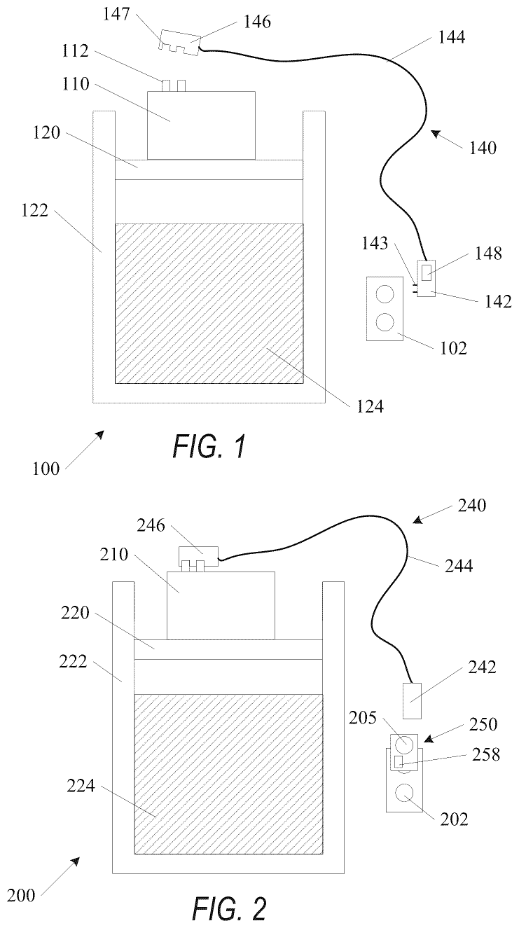

FIG. 1 shows a charging system 100 for a rechargeable battery. A battery 110 is shown, the battery 110 including battery contacts 112 or terminals. In one example, the battery 110 includes a lithium-ion battery, although the invention is not so limited. Other rechargeable battery chemistries are within the scope of the invention.

The charging system 100 includes a fire suppressant 124, within a tank 122. A thermally destructible surface 120 is suspended over the fire suppressant 124. The charging system 100 of FIG. 1 further includes electrical charging supply system 140.

The electrical charging supply system 140 includes electrical charging supply lines 144. In the example of FIG. 1, a battery connector 146 is includes on one end of the electrical charging supply system 140, and an outlet connector 142 is coupled to an opposite end of the electrical charging supply system 140.

The battery connector 146 includes a plug 147 that is configured to mate with corresponding battery contacts 112. In the example shown, the plug includes a female connection, and the battery contacts 112 are male, although the invention is not so limited. Similarly, the outlet connector 142 is shown with prongs 143. An outlet 102 is shown to provide power to the charging system 100. In one example, the outlet 102 includes a standard wall outlet.

In one example, a power transformer is included in the electrical charging supply system 140. In one example, the power transformer is included in the outlet connector 142. In one example, the power transformer is included in the plug 147. In one example, a circuit breaker 148 is included in the electrical charging supply system 140. In one example, the circuit breaker 148 is included in the outlet connector 142. In one example, the circuit breaker 148 is included in the plug 147.

FIG. 2 shows a charging system 200. Similar to the example of FIG. 1, the charging system 200 includes a battery 210, a fire suppressant 224, within a tank 222, and a thermally destructible surface 220 suspended over the fire suppressant 224. An electrical charging supply system 240 is shown with a battery connector 246 coupled to terminals of the battery 210, and electrical charging supply lines 244 are coupled between the battery connector 246 and an outlet connector 242. In the charging system 200 of FIG. 2, the electrical charging supply system 240 is not plugged directly into an outlet 202. An adapter 250 is included as an intermediate electrical component between the electrical charging supply system 240 and the outlet 202. The adapter 250 in FIG. 2 includes a circuit breaker 258, and a second outlet 205. When plugged into a first outlet 202, the adapter 250 then places the circuit breaker 258 in line with power from the outlet 202 to the battery 210. The outlet connector 242 can be plugged into the second outlet 205 to complete the power delivery through the electrical charging supply system 240 to the battery 210. This configuration allows inclusion of a circuit breaker 258 while still allowing use of a transformer and existing cords and plug configuration that come with a product and are specifically compatible with a specific rechargeable battery.

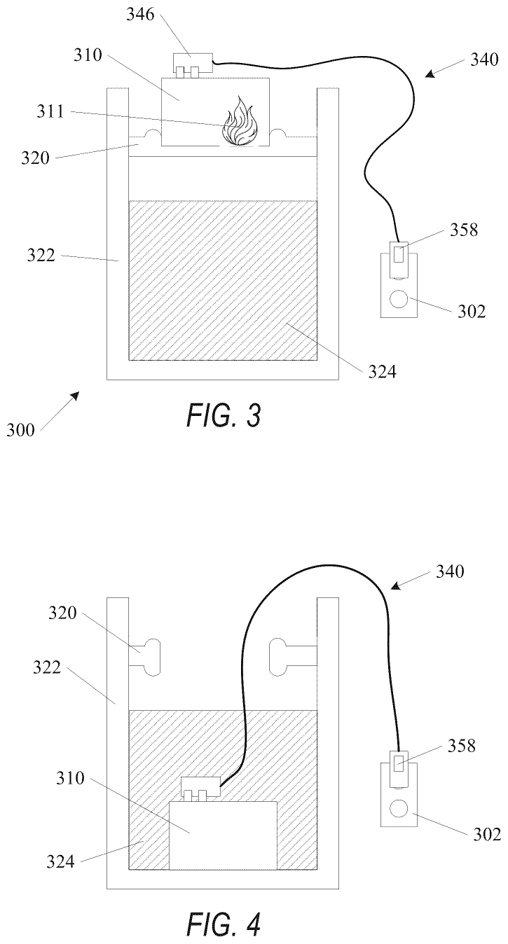

FIG. 3 shows a charging system 300 including an electrical charging supply system 340 similar to charging systems 100 or 200 as described above. Similar to other examples, in FIG. 3, the charging system 300 includes a fire suppressant 324, within a tank 322. A battery 310 is suspended over the fire suppressant 324 by a thermally destructible surface 320. An electrical charging supply system 340 is shown with a battery connector 346 coupled to terminals of the battery 310. In the charging system 300, the electrical charging supply system 340 is plugged directly into an outlet 302, although the invention is not so limited. In other examples, as illustrated in FIG. 2, the electrical charging supply system 340 is plugged into an adapter that is between the electrical charging supply system 340 and the outlet 302.

In one example, the thermally destructible surface 320 is substantially solid, and encloses the tank 322. In other examples, the thermally destructible surface 320 includes rods, or a mesh, or other supports that hold the battery 310 is suspended over the fire suppressant 324. The thermally destructible surface 320 need only have enough structure to hold the battery 310 suspended. In examples where the thermally destructible surface 320 encloses the tank 322, one advantage includes the ability to place the battery 310 on the thermally destructible surface 320 more easily, without concern for any particular orientation on location on the thermally destructible surface 320.

In FIG. 3, as a result of damage or failure of a component of a battery 310, a fire 311 or thermal discharge is initiated in the battery 310. Heat from the fire 311 or thermal discharge begins to compromise a thermally destructible surface 320. In FIG. 4, the thermally destructible surface 320 is fully compromised, and the battery 310 falls through the thermally destructible surface 320 into a fire suppressant 324.

If a rechargeable battery fails and experiences thermal runaway, when a user is not paying attention (for example is sleeping and charging a battery overnight) the result can be a dangerous risk of property damage or other harm from a subsequent fire ignited by the failing battery in thermal runaway. Using examples of configurations described, any thermal runaway is safely contained without risk of additional fire damage.

Examples of thermally destructible surface 320 include, but are not limited to, meltable materials, materials that facture when exposed to heat, etc. In one example, the thermally destructible surface 320 includes a meltable polymer. In one example, the thermally destructible surface 320 includes a polymer foam. A foam material may provide increased structural support before thermal compromise, and more quickly transition after melting to allow the battery 310 to fall through the thermally destructible surface 320. In one example, the thermally destructible surface 320 is non-flammable. A number of polymer materials will melt, but will not catch fire themselves when exposed to the fire 311.

In one example, the fire suppressant 324 includes water. In one example, the fire suppressant 324 includes a foam. In one example, the fire suppressant 324 includes a powder. In one example, the fire suppressant 324 includes a non-electrically conducting media, or minimally electrically conducting media.

In one example, the charging system 300 includes a circuit breaker 358. In an example where the fire suppressant 324 includes water, the circuit breaker 358 may trip and disconnect any electricity to the electrical charging supply system 340 once the battery 310 is in the fire suppressant 324 as shown in FIG. 4.

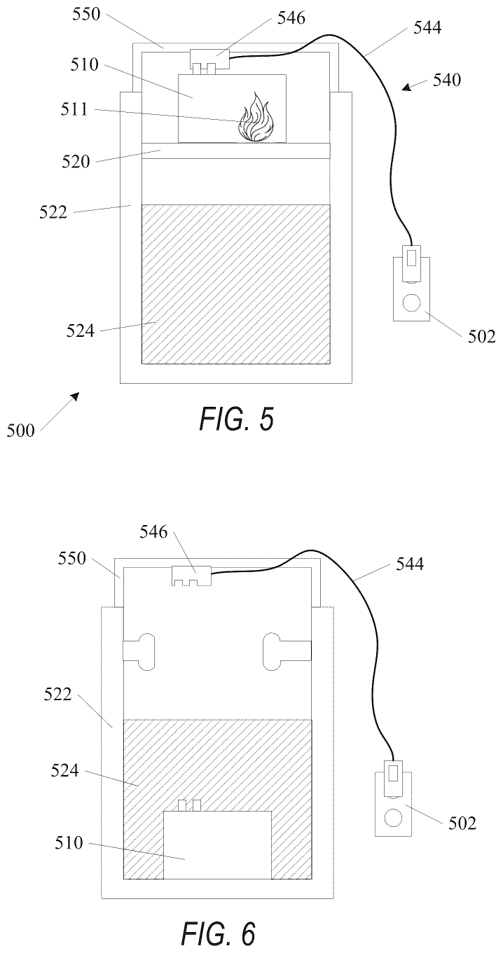

FIG. 5 shows a charging system 500 including an electrical charging supply system 540 similar to other systems described. Similar to other examples, in FIG. 5, the charging system 500 includes a fire suppressant 524, within a tank 522. A battery 510 is suspended over the fire suppressant 524 by a thermally destructible surface 520. An electrical charging supply system 540 is shown with the battery connector 546 coupled to terminals of a battery 510. In the charging system 500, the electrical charging supply system 540 is plugged directly into an outlet 502, although the invention is not so limited. In other examples, as illustrated in FIG. 2, the electrical charging supply system 540 is plugged into an adapter that is between the electrical charging supply system 540 and the outlet 502.

In the example of FIG. 5, the battery connector 546 is coupled to a support 550 to hold electrical charging supply lines 544 in place above the fire suppressant 524 if the battery 510 drops through the thermally destructible surface 520. As in FIG. 3, as a result of damage or failure of a component of a battery 510, a fire 511 or thermal discharge is initiated in the battery 510. In FIG. 6, the thermally destructible surface 520 is fully compromised, and the battery 510 falls through the thermally destructible surface 520 into the fire suppressant 524. Because of the support 550, the battery connector 546 and/or the electrical charging supply lines 544 remain above the fire suppressant 524 while the battery 510 falls into the fire suppressant 524, which safely extinguishes the fire 511. The addition of the support 550 reduces or eliminates any electrical components from remaining connected to the outlet 502 when also exposed to the fire suppressant 524. Only the battery 510 is immersed in the fire suppressant 524. In the example of FIGS. 5 and 6, gravity acts on the battery 510 once the thermally destructible surface 520 is compromised and the gravity unplugs the battery 510 from the battery connector 546.

Although a fire suppressant is shown in examples described, the invention is not so limited. In another example, just the tank, without any fire suppressant, contains any fire from the battery and allows the battery to burn safely until to fire burns out on its own. In examples that do not include a fire suppressant, the tank is formed from a fire-resistant material, such as metal stone, ceramic, etc.

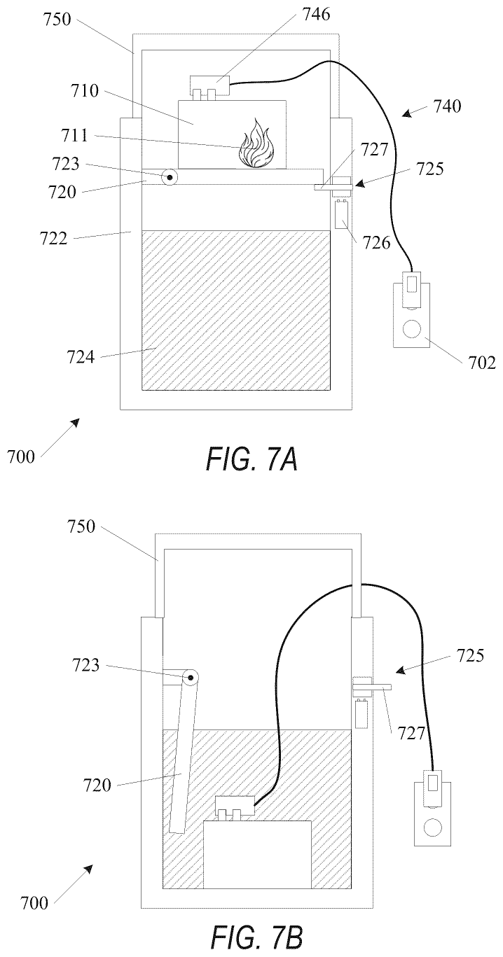

FIG. 7A shows a charging system 700 including an electrical charging supply system 740 similar to other systems described. Similar to other examples, in FIG. 7A, the charging system 700 includes a fire suppressant 724, within a tank 722. A battery 710 is suspended over the fire suppressant 724 by a platform 720. An electrical charging supply system 740 is shown with the battery connector 746 coupled to terminals of a battery 710. In the charging system 700, the electrical charging supply system 740 is plugged directly into an outlet 702, although the invention is not so limited. In other examples, as illustrated in FIG. 2, the electrical charging supply system 740 is plugged into an adapter that is between the electrical charging supply system 740 and the outlet 702.

As in FIG. 3, as a result of damage or failure of a component of a battery 710, a fire 711 or thermal discharge is initiated in the battery 710. In the configuration of FIG. 7A, the platform 720 includes a hinge configured to pivot the platform 720 and allow the battery 710 to enter the fire suppressant 724 to extinguish the fire 711. A controlled release mechanism 725 is shown, holding an end of the platform 720. The controlled release mechanism 725 includes a bolt 727 in the example, shown, although other systems, such as magnetic systems, etc. are within the scope of the invention. The controlled release mechanism 725 is operated from a triggering signal, such as a heat or smoke sensor. In operation, when a fire 711 is detected, the controlled release mechanism 725 is actuated, for example using a solenoid, or other mechanism.

In one example, an actuator battery 726 is included locally, and coupled to the controlled release mechanism 725. In other examples, the controlled release mechanism 725 does not require power, and is actuated mechanically, once a triggering event occurs. In one example, a thermal trigger, such as a melting retainer is included. When the melting trigger melts, a spring is released that actuates the controlled release mechanism 725.

In one example, a circuit is included and coupled to the controlled release mechanism 725. The circuit may include a low actuator battery alarm to alert a user that the actuator battery needs to be replaced. It is important that the controlled release mechanism 725 is in an operable state. As such, a low batter alarm, or a system that does not require power, is desirable to ensure operability of the controlled release mechanism 725. In one example, the circuit may include a second alarm to indicate that the controlled release mechanism 725 has been actuated. Even though devices and methods described will extinguish a battery 710 in thermal runaway automatically, it is also beneficial to alert a user that the system has been triggered, so that they may monitor the situation and take any additional steps for safety, if necessary.

In one example, the fire suppressant 724 includes a liquid. In one example, the liquid fire suppressant 724 includes water, although the invention is not so limited. Other additives may be included in water to enhance fire suppression. When a liquid is used as the fire suppressant 724 it is advantageous to ensure that the platform 720 move quickly to allow the battery 710 to enter the fire suppressant 724. In one example, the platform 720 includes openings to facilitate ease of motion through the fire suppressant. Examples of openings includes a number of holes in the platform 720, or other shapes of openings. In one example, the platform 720 is formed from a mesh, that provides support for the battery 710, and also provides numerous openings in the mesh to allow the platform 720 to move quickly through water, or other fire suppressant 724 once the controlled release mechanism 725 is actuated.

Also shown in FIGS. 7A and 7B, a fireproof lid 750 may be included to contain any portion of fire 711 before triggering of the controlled release mechanism 725, or to contain any residual flames before they are completely extinguished by the fire suppressant 724. In one example, one or more of the components of the charging system 700 are formed from stainless steel. Stainless steel has advantages, including an ability to resist corrosion from water or other fire suppressant liquids. Stainless steel is also more resistant to damage from the flames of a battery 710 in thermal runaway. As such, components such as the fireproof lid 750 will benefit from being made of stainless steel. Stainless steel is more resistant to damage from thermal runaway flames that other metals such as low carbon steel or aluminum.

In one example, the controlled release mechanism 725 includes a thermally destructible trigger, and the bolt 727 is biased with a component, such as a spring. When the thermally destructible trigger melts, or burns, or otherwise is compromised, the controlled release mechanism 725 releases the bolt 727 and the spring or other biasing mechanism drives the bolt out to a retracted location. This allows the platform 720 to pivot and immerse the battery 710 in the fire suppressant 724.

FIG. 7B shows the platform 720 after release of the bolt 727. The bolt 727 is shown in a disengaged position, and the platform 720 pivots about the hinge 723. As shown in FIG. 7B, once the battery 710 is in the fire suppressant 724, the fire 711 is extinguished, or otherwise safely contained.

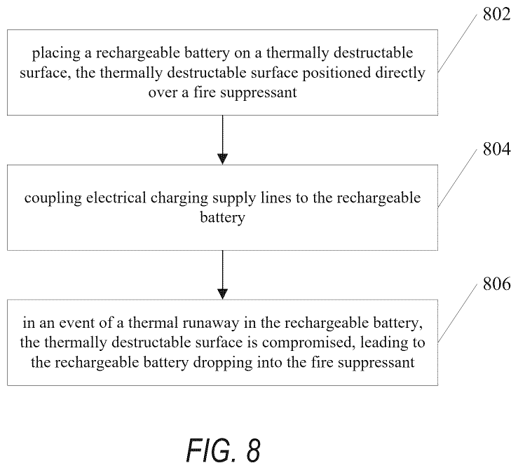

FIG. 8 shows an example method of charging a rechargeable battery. In operation 802, a rechargeable battery is placed on a thermally destructible surface. The thermally destructible surface is positioned directly over a fire suppressant. In operation 804, electrical charging supply lines are coupled to the rechargeable battery. In operation 806, in an event of a thermal runaway in the rechargeable battery, the thermally destructible surface is compromised, leading to the rechargeable battery dropping into the fire suppressant.

To better illustrate the method and apparatuses disclosed herein, a non-limiting list of aspects is provided here:

Aspect 1. A method of charging a rechargeable battery, comprising: placing a rechargeable battery on a thermally destructible surface, the thermally destructible surface positioned directly over a fire suppressant; coupling electrical charging supply lines to the rechargeable battery; and wherein in an event of a thermal runaway in the rechargeable battery, the thermally destructible surface is compromised, leading to the rechargeable battery dropping into the fire suppressant.

Aspect 2. The method of aspect 1, wherein placing the rechargeable battery includes placing over a fire suppressant that includes water.

Aspect 3. The method of aspect 1, wherein placing the rechargeable battery includes placing over a fire suppressant that includes a fire suppressing foam.

Aspect 4. The method of aspect 1, wherein placing the rechargeable battery includes placing over an enclosed tank that includes the fire suppressant.

Aspect 5. The method of aspect 1, wherein placing the rechargeable battery includes placing on a thermally destructible surface that is meltable.

Aspect 6. The method of aspect 1, wherein placing the rechargeable battery includes placing on a polymer thermally destructible surface.

Aspect 7. The method of aspect 1, wherein placing the rechargeable battery includes placing on a non-flammable thermally destructible surface.

Aspect 8. The method of aspect 1, wherein placing the rechargeable battery includes placing a lithium-ion rechargeable battery.

Aspect 9. The method of aspect 1, further including activating a circuit breaker to break electricity in the electrical charging supply lines in the event of the rechargeable battery dropping into the fire suppressant.

Aspect 10. The method of aspect 1, further including unplugging the rechargeable battery from the electrical charging supply lines by gravity in the event of the rechargeable battery dropping into the fire suppressant.

Aspect 11. A charging system for a rechargeable battery, comprising: a fire suppressant; a thermally destructible surface suspended over the fire suppressant; and a support to hold electrical charging supply lines in place above the fire suppressant if the rechargeable battery drops through the thermally destructible surface.

Aspect 12. The charging system of aspect 11, further including a charging transformer.

Aspect 13. The charging system of aspect 11, further including one or more electrical plugs configured to release under gravity if the rechargeable battery drops through the thermally destructible surface.

Aspect 14. A charging system for a rechargeable battery, comprising: a fire suppressant; a thermally destructible surface suspended over the fire suppressant; a circuit breaker adapted to interrupt power to a power supply line if a short circuit is detected.

Aspect 15. The charging system of aspect 14, wherein the circuit breaker is a discrete component separate from electrical charging supply lines.

Aspect 16. The charging system of aspect 15, wherein the circuit breaker is a discrete component separate from a transformer.

Aspect 17. The charging system of aspect 16, wherein the circuit breaker includes an outlet plug for a wall outlet and an outlet plug to accept a charging transformer.

Aspect 18. A charging system for a rechargeable battery, comprising: a fire suppressant; a surface suspended over the fire suppressant; and a thermally activated actuator coupled to the surface, the thermally activated actuator configured such that when actuated, the surface is moved, allowing a charging battery to drop into the fire suppressant.

Aspect 19. The charging system of aspect 18, wherein the thermally activated actuator is coupled to an actuator battery to power the thermally activated actuator.

Aspect 20. The charging system of aspect 19, further including a low actuator battery alarm to alert a user that the actuator battery needs to be replaced.

Aspect 21. The charging system of aspect 18, wherein the thermally activated actuator includes a solenoid.

Aspect 22. The charging system of aspect 18, wherein the fire suppressant includes a liquid and wherein the surface includes openings to facilitate ease of motion through the fire suppressant.

These and other examples and features of the present infusion devices, and related methods will be set forth in part in the above detailed description.

This overview is intended to provide non-limiting examples of the present subject matter—it is not intended to provide an exclusive or exhaustive explanation.

1The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. 1Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of charging a rechargeable battery, comprising:
placing a rechargeable battery on a thermally destructible surface, the thermally destructible surface positioned directly over a fire suppressant;
coupling electrical charging supply lines to the rechargeable battery; and
wherein in an event of a thermal runaway in the rechargeable battery, the thermally destructible surface is compromised, leading to the rechargeable battery dropping into the fire suppressant.

2. The method of claim 1, wherein placing the rechargeable battery includes placing over a fire suppressant that includes water.

3. The method of claim 1, wherein placing the rechargeable battery includes placing over a fire suppressant that includes a fire suppressing foam.

4. The method of claim 1, wherein placing the rechargeable battery includes placing over an enclosed tank that includes the fire suppressant.

5. The method of claim 1, wherein placing the rechargeable battery includes placing on a thermally destructible surface that is meltable.

6. The method of claim 1, wherein placing the rechargeable battery includes placing on a polymer thermally destructible surface.

7. The method of claim 1, wherein placing the rechargeable battery includes placing on a non-flammable thermally destructible surface.

8. The method of claim 1, wherein placing the rechargeable battery includes placing a lithium-ion rechargeable battery.

9. The method of claim 1, further including activating a circuit breaker to break electricity in the electrical charging supply lines in the event of the rechargeable battery dropping into the fire suppressant.

10. The method of claim 1, further including unplugging the rechargeable battery from the electrical charging supply lines by gravity in the event of the rechargeable battery dropping into the fire suppressant.

11. A charging system for a rechargeable battery, comprising:
a fire suppressant;
a thermally destructible surface suspended over the fire suppressant; and
a support to hold electrical charging supply lines in place above the fire suppressant if the rechargeable battery drops through the thermally destructible surface.

12. The charging system of claim 11, further including a charging transformer.

13. The charging system of claim 11, further including one or more electrical plugs configured to release under gravity if the rechargeable battery drops through the thermally destructible surface.

14. A charging system for a rechargeable battery, comprising:
a fire suppressant;
a thermally destructible surface suspended over the fire suppressant;
a circuit breaker adapted to interrupt power to a power supply line if a short circuit is detected.

15. The charging system of claim 14, wherein the circuit breaker is a discrete component separate from electrical charging supply lines.

16. The charging system of claim 15, wherein the circuit breaker is a discrete component separate from a transformer.

17. The charging system of claim 16, wherein the circuit breaker includes an outlet plug for a wall outlet and an outlet plug to accept a charging transformer.

18. A charging system for a rechargeable battery, comprising:
a fire suppressant;
a surface suspended over the fire suppressant; and
a thermally activated actuator coupled to the surface, the thermally activated actuator configured such that when actuated, the surface is moved, allowing a charging battery to drop into the fire suppressant.

19. The charging system of claim 18, wherein the thermally activated actuator is coupled to an actuator battery to power the thermally activated actuator.

20. The charging system of claim 19, further including a low actuator battery alarm to alert a user that the actuator battery needs to be replaced.

21. The charging system of claim 18, wherein the thermally activated actuator includes a solenoid.

22. The charging system of claim 18, wherein the fire suppressant includes a liquid and wherein the surface includes openings to facilitate ease of motion through the fire suppressant.
